(19) United States
(12) Patent Application Publication
(10) Pub. No.: US 2008/0009532 A1
(43) Pub. Date: Jan. 10, 2008

(54) Antimicrobially Finished Solid Preparations

(76) Inventor: Peter Wachtler, Krefeld (DE)

Correspondence Address: LANXESS CORPORATION, 111 RIDC PARK WEST DRIVE, PITTSBURGH, PA, 15275-1112, US

(21) Appl. No.: 11/794,869

(22) PCT Filed: Dec. 16, 2005
(86) PCT No.: PCT/EP05/13596

§ 371 Date: Jul. 6, 2007

(30) Foreign Application Priority Data
Jan. 13, 2005 (DE) 10 2005 001 566:2

(51) Int. Cl. A01N 43/80; A01N 25/08; A01P 1/00

(52) U.S. Cl. 514/373; 514/372

(57) ABSTRACT

The antimicrobially finished aqueous preparations of water-insoluble solids comprising 1,2-benzisothiazolin-3-one (BIT) and at least one further biocidally active compound are distinguished by rapid onset of action with good long-term action (even at low concentration of the biocide mixtures used) and good environmental compatibility.

The present invention relates to antimicrobially finished aqueous preparations of water-insoluble solids comprising 1,2-benzisothiazolin-3-one (BIT) and at least one further biocidally active compound, and to a process for preparing these preparations, and also to the use of active compound mixtures of 1,2-benzisothiazolin-3-one and at least one further biocidally active compound for protecting preparations of water-insoluble solids.

By virtue of their good processibility or the option of tailored adjustment of customer-specific substance parameters, aqueous preparations such as suspensions or dispersions of water-insoluble solids such as minerals, fillers or pigments are raw material components frequently used in practice. These products are characterized in that they comprise a water-insoluble solid component divided, i.e. suspended, dispersed or slurried in water with addition of a dispersant and, if appropriate, further additives, such that mixtures having a solids fraction of 40-80% are formed. Kaolin or calcium carbonate slurries, for example, are used in large amounts in the paper industry as a filler in the wet-end or as a component of coat slips in the preparation of coated paper. In spite of the fact that such aqueous suspensions or dispersions, based on the percentage by weight, are mainly inorganic preparations, practical experience shows that these products, too, may, under certain circumstances, be subject to a massive attack by microorganisms resulting in intolerable changes in the substance properties. Known results of a microbial attack of such aqueous suspensions or dispersions of minerals, fillers or pigments are, for example, changes in viscosity, discolorations or reductions in odour quality. Owing to the economical consequences of faulty charges for example in the paper industry, it is thus imperative to provide a technology which reliably prevents the above-described disadvantages of product damage caused by microbial destruction.

In the past, there has been no lack of efforts to provide technologies for preventing microbial and/or bacterial destruction of mineral slurries.

To date, the most promising method for ensuring an acceptable microbiological quality of mineral slurries over the entire life cycle (production, storage, transport, use) is the addition of preservatives or biocidal products. By flanking measures in the field of operational hygiene, it is possible to support and optimize, if appropriate, the activity of the biocide products used in a manner known to the person skilled in the art.

However, all attempts undertaken to date for preparing sufficiently microbiologically stable mineral slurries by addition of preservatives and biocide products have one or the other disadvantage:

Dazomet, a biocide with good activity in principle, suffers in particular in products adjusted to an alkaline pH (for example talcum or calcium carbonate slurries) rapid degradation with release of toxic and highly odorous gases.

Bronopol, an excellent bactericide, is, under the in some cases harsh conditions (high pH and temperatures) of slurry preparation and processing, under unfavourable conditions degraded more rapidly than it can display its activity.

Formaldehyde and the formaldehyde-releasing substances derived therefrom are effective and sufficiently stable preservatives, in particular against bacteria. However, owing to toxicological objections and legal provisions, in many countries these proven preservatives may no longer be used.

Benzisothiazolinone, a highly stable and easily processible preservative, has an unbalanced activity spectrum, in particular against certain bacteria species which dominate in mineral slurries, and is furthermore a biocide which acts relatively slowly. Additionally, this active compound has the disadvantage that the high dosages required are linked to a relatively high price, so that for economical reasons, too, benzisothiazolinone has not been able to achieve a prominent position in the preservation of mineral slurries of the type described above.

Accordingly, there was still a need for providing novel and more reliable methods for controlling unwanted microbial growth in the production, the storage, the transport and the processing of aqueous preparations of water-insoluble solids, such as, for example, aqueous preparations of minerals, fillers or pigments, in particular those having a relatively high pH, such as, for example, calcium carbonate or talcum slurries. Here, it is desirable in principle to achieve, firstly, a biocidal effect which is as strong as possible using the available active compounds and, secondly, that only relatively small amounts of the active compounds are required to achieve this purpose. However, 1,2-benzisothiazolin-3-one, which per se is stable even under extreme pH and temperatures, has, as single component, an activity which is too low and not compatible economically.

Accordingly, it was the object of the invention to provide an aqueous preparation of water-insoluble solids which avoids the problems discussed above and which is very well protected against microbial attack during the entire production process and also the logistic processing that follows, thus ensuring perfect microbiological quality of the products until final use.

Surprisingly, it has now been found that mixtures based on 1,2-benzisothiazolin-3-one (benzisothiazolinone, BIT) and at least one further antimicrobially active component lead to unexpectedly good results in the preservation of aqueous preparations of water-insoluble solids, in particular of preparations which are difficult to protect, such as calcium carbonate or talcum slurries. Reliable and long-lasting preservation of the abovementioned products with the known container preservatives is difficult, since the pH and temperature conditions given above are particularly demanding with a view to the stability of the preservatives to be used.

Accordingly, the present invention provides antimicrobially finished aqueous compositions of water-insoluble solids comprising a mixture of 1,2-benzisothiazolin-3-one and at least one further biocidally active compound.

Suitable further biocidally active compounds are, in addition to 1,2-benzisothiazolin-3-one, preferably the following compounds:
isothiazolinones from the group consisting of 5-chloro-2-methyl-4-isothiazolin-3-one (CMIT) and 2-methyl-4-isothiazolin-3-one (MIT);
formaldehyde;
formaldehyde-releasing substances based on O-formals, such as, for example, benzyl hemiformal, ethylene glycol bishemiformal, ethylene glycol hemiformal;
formaldehyde-releasing substances based on N-formals, such as, for example, 3-dimethylol-5,5-dimethylhydantoin (DMDMH), tetramethylolacetylenediurea (TMAD), N,N′-dimethylolurea, N-methylolurea, 4,4-dimethyl-1,3-oxazolidine; diazolidinylurea, imidazolidinylurea, 3,3′-methylene-bis(5-methyloxazolidine), 1,3,5-hexahydrotriazine, sodium(hydroxymethyl)glycinate, 7a-ethyldihydro-1H,3H,5H-oxazolo[3,4-c]oxazole;
bromine-containing biocides, such as 2-bromo-2-nitropropane-1,3-diol (bronopol) and dibromodicyanobutane (DBDCB);
o-phenylphenol.

Particularly preferably, the preparations according to the invention comprise mixtures of 1,2-benzisothiazolin-3-one with the further biocidally active compounds 5-chloro-2-methyl-4-isothiazolin-3-one and 2-methyl-4-isothiazolin-3-one.

The aqueous preparations according to the invention are preferably suspensions, dispersions or slurries.

The water-insoluble solids in the preparations according to the invention are preferably natural or synthetic minerals, fillers or pigments based on natural or synthetic raw materials, such as, for example, aluminium hydroxide, aluminium silicate, titanium dioxide, iron oxide, kaolin, calcium carbonate or talcum.

The preparations according to the invention preferably have a content of water-insoluble components of from 40 to 80% by weight.

The further biocidally active compound used in the preparations according to the invention is preferably a mixture of 5-chloro-2-methyl4-isothiazolin-3-one and 2-methyl-4-isothiazolin-3-one in a weight ratio of 1-50 g (1-50 ppm) in particular 5-30 g (5-30 ppm), based on 1 metric ton of the preparations according to the invention.

The concentrations of the biocidally active compounds in the preparations according to the invention are in the range of 10-500 ppm for 1,2-benzisothiazolin-3-one and in the range of 1-5000 ppm for the second component or the sum of the further components, in each case based on the total weight of the preparation.

The ratios of 1,2-benzisothiazolin-3-one (BIT) and the second or further active compound component(s) may vary over a wide range. In the preparations according to the invention, the ratio of benzisothiazolinone (BIT) to the second active compound component or the sum of the further active compound components is usually a weight ratio of from 100:1 to 1:100, preferably from 50:1 to 1:50, particularly preferably from 10:1 to 1:10.

The preparations according to the invention are preferably aqueous suspensions, dispersions or slurries of calcium carbonate or talcum or kaolin in water, the solids content being 40-80% by weight and the content of the sum of biocidally active compounds being 1-5000 ppm, in each case based on the total weight of the preparation.

The aqueous preparations according to the invention are highly resistant to attack by microorganisms, in particular by aerobic or anaerobic bacteria species, thus allowing problem-free handling of the products during production, storage, transport and final use.

Examples of microorganism species which are able to colonize the aqueous suspensions, dispersions or slurries of minerals, fillers or pigments are in particular aerobic and anaerobic bacteria species. Without limiting the scope of the invention, the following species may be mentioned:

Alcaligenes, such as Alcaligenes faecalis

Bacillus, such as Bacillus firmus

Corynebacterium, such as Corynebacterium aquaticum

Desulfovibrio desulfuricans

Enterobacter, such as Enterobacter aerogenes,

Enterococcen, such as Enterococcus faecalis

Escherichia, such as Escherichia coli,

Proteus, such as Proteus vulgaris

Pseudomonas, such as Pseudomonas aeruginosa,

Schewanella, such as Schewanella putrefaciens

Serratia, such as Serratia marescens

Staphylococcus, such as Staphylococcus aureus.

The antimicrobially finished preparations according to the invention are distinguished by the following characteristics:
rapid onset of action
good long-term activity in spite of low concentration of the biocide mixtures used
low toxicity to man and mammals at the concentration used
well tolerated.

In addition, the antimicrobially finished preparations according to the invention are, surprisingly, distinguished in that the incorporated biocidally active compounds show an unexpectedly high synergistic enhancement of activity at specific mixing ratios. As a consequence, the use concentrations, required for the antimicrobial finish, of the active compound components according to the invention can be reduced compared to the concentrations required in the case of the respective individual active compounds. This is extremely advantageous from economical, ecological and technical points of view and contributes to increasing the preservation quality.

In addition, the preparations according to the invention may comprise one or more other biocidally active compounds. The following compounds may be mentioned as preferred mixing partners:

benzalkonium chloride

benzyl alcohol

2,4-dichlorobenzyl alcohol

bromochlorodimethylhydantoin

butyl paraben, ethyl paraben, methyl paraben, propyl paraben

cetylpyridinium chloride

dazomet

2,2-dibromo-3-nitrilopropionamide (DBNPA)

dodecylguanidine

methylene bisthiocyanate

didecyldimethylammonium chloride

2-phenoxyethanol

2-phenoxypropanols

Phenylethyl alcohol

poly(hexamethylenebiguanide) hydrochloride (PHMB)

The antimicrobially finished aqueous preparations according to the invention can be produced by dispersing, suspending or slurrying water-insoluble solids, preferably minerals, pigments or fillers, with addition of a dispersant and, if appropriate, further additives in water, and treating with the biocidally active compound mixture 1,2-benzisothiazolin-3-one and at least one further biocidal compound, if appropriate with addition of one or more solvents and, if appropriate, further antimicrobially active compounds.

The present invention furthermore provides the use of a mixture of 1,2-benzisothiazolin-3-one and at least one further biocidally active compound from the group of the isothiazolinones, formaldehyde and formaldehyde-releasing substances, the bromine-containing biocides and o-phenylphenol for protecting aqueous preparations of water-insoluble solids, in particular suspensions, dispersions and slurries of minerals, pigments or fillers.

Very particular preference is given to the use according to the invention of a mixture of 1,2-benzisothiazolin-3-one and at least one further biocidally active compound from the group of the isothiazolinones, formaldehyde and formaldehyde-releasing substances, the bromine-containing biocides and o-phenylphenol for protecting aqueous calcium carbonate or talcum slurries.

Preferred isothiazolinones, formaldehyde-releasing substances and bromine-containing biocides are the abovementioned compounds used in the preparations according to the invention.

The mixtures to be used according to the invention can be incorporated into the preparations to be protected during the production of these preparations, during storage or before and/or during transport of the preparations, in a manner known per se.

Depending on their respective physical and/or chemical properties and/or the specific operational requirements of the preservation problem to be solved, the biocidally active compound mixtures to be used according to the invention can be applied either separately in the form of a metered addition of the individual active compounds, in which case the concentration ratio may be individually adjusted depending on the preservation problem present, or a finished active compound mixture may be metered in. For this, it is possible to convert the biocidally active compound mixture beforehand into a customary formulation, such as, for example, a solution, an emulsion, a suspension, a powder, a foam, pastes, granules, aerosols and microencapsulations in polymeric substances.

These formulations may be prepared in a manner known per se, for example by mixing the mixture or the individual active compounds comprised therein with extenders, i.e. liquid solvents, pressurized liquefied gases and/or solid carriers, if appropriate with the use of surfactants, i.e. emulsifiers and/or dispersants and/or foam formers. If the extender used is water, it is also possible to use, for example, organic solvents as additional auxiliary solvents. Essentially, suitable liquid solvents include: alcohols, such as butanol or glycol, and also ethers and esters thereof, ketones, such as acetone, methyl ethyl ketone, methyl isobutyl ketone or cyclohexanone, strongly polar solvents, such as dimethylformamide, N-methylpyrrolidone or dimethyl sulphoxide, and also water; liquefied gaseous extenders or carriers are to be understood as meaning liquids which are gaseous at ambient temperature and under atmospheric pressure, for example aerosol propellants, such as halogenated hydrocarbons, and also butane, propane, nitrogen and carbon dioxide; suitable solid carriers are: for example ground natural minerals, such as kaolins, clays, talc, chalk, quartz, attapulgite, montmorillonite or diatomaceous earth, and ground synthetic minerals, such as finely divided silica, aluminium oxide and silicates; suitable solid carriers for granules are: for example crushed and fractionated natural rocks, such as calcite, marble, pumice, sepiolite and dolomite, and also synthetic granules of inorganic and organic meals, and granules of organic material such as sawdust, coconut shells, maize cobs and tobacco stalks; suitable emulsifiers and/or foam formers are: for example nonionic and anionic emulsifiers, such as polyoxyethylene fatty acid esters, polyoxyethylene fatty alcohol ethers, for example alkylaryl polyglycol ethers, alkylsulphonates, alkyl sulphates, arylsulphonates, and also protein hydrolysates; suitable dispersants are: for example lignosulphite waste liquors and polyacrylates.

Tackifiers and thickeners such as carboxymethylcellulose, methylcellulose and natural and synthetic polymers in the form of powders, granules or latices, such as gum Arabic, polyvinyl alcohol, polyvinyl acetate, and also natural phospholipids, such as cephalins and lecithins, and synthetic phospholipids can be used in the formulations. Other possible additives are mineral and vegetable oils.

The active compound combinations to be used according to the invention and produced as described above comprise the active compounds in concentrations of 5-50% by weight, preferably 5-30% by weight, calculated as the sum of all active compound components.

The use concentrations of the active compound combinations to be used depend on the nature and the occurrence of the microorganisms to be controlled, the initial microbial load, and on the expected storage time of the suspensions or dispersions of minerals, fillers or pigments to be protected. The optimum amount to be employed can be determined by preliminary tests and test series on a laboratory scale and by supplementary operational tests. In general, the use concentrations are in the range from 0.01 to 5% by weight, preferably from 0.05 to 1.0% by weight, of the mixtures according to the invention, based on the suspensions or dispersions of minerals, fillers or pigments to be protected.

The example below documents the good microbiological stability of the suspensions or dispersions of minerals, pigments or fillers protected with the mixtures according to the invention:

### EXAMPLE

There are certain germs which are particularly relevant in practice, such as, for example, Pseudomonas sp., to which the mineral slurries according to the invention are notable for a surprisingly good antimicrobial resistance. In particular, by the use according to the invention of the biocidally active compound components, a synergistic effect results, i.e. the activity of the mixtures is better than would have been expected judging from the activity of the individual components.

Microbiological Stress Test

The microbiological stress test examines the susceptibility of water-based systems to microbial attack and the efficacy of preservatives. To this end, defined concentrations of the preservatives are incorporated into the water-based systems. To simulate reality-like conditions, depending on the medium to be examined, the sample may be stored at elevated temperatures (for example for 7 days at 40° C., for 3 days at 60° C. or the like) prior to carrying out the actual preservation test, in order to evaluate the preservatives to be tested under conditions which are as realistic as possible. After the preliminary work has been concluded, there is, at weekly intervals, a contamination with microorganisms of a defined type over a test period of at most 6 weeks. 2-3 and 7 days after each contamination it is established by germ number determination, whether there has been a complete kill or at least an inhibition of proliferation of the microorganisms introduced, compared to the non-preserved control samples.

On account of the microorganism populations known to predominate in mineral suspensions and dispersions, for the experiment, a mixture of the following bacterial species was used for the test:

Pseudomonas aeruginosa

Pseudomonas fluorescens

Pseudomonas oleovorans

Pseudomonas rubescens

Pseudomonas stutzeri

Alcaligenes faecalis

Citrobacter freundii

Corynebacterium sp.

Very good efficacy is achieved when the preserved samples effect a kill of the microorganisms introduced even after 6 contamination cycles. A satisfactory activity is achieved if, compared to the unpreserved sample, a strongly reduced microbe concentration is observed.

Results

Using a calcium carbonate slurry (solids content 70-75%), a preservation stress test was carried out in accordance with the above scheme. After incorporation of the respective biocide products at the stated concentrations, the samples were exposed to thermal stress at 60° C. for 3 days in order to identify unstable active compound components in the biocide products even at this phase of the experiment by subsequent loss of activity.

TABLE

| Biocidal | Week | Week | Week | | | |
|---|---|---|---|---|---|---|
| dosages | 1 | 2 | 3 | Week 4 | Week 5 | Week 6 |
| benzisothiazolinone | | | | | | |
| 100 ppm | ok | spoilt | spoilt | spoilt | spoilt | spoilt |
| 150 ppm | ok | ok | spoilt | spoilt | spoilt | spoilt |
| 200 ppm | ok | ok | ok | spoilt | spoilt | spoilt |
| benzisothiazolinone & | | | | | | |
| CMIT/MIT | | | | | | |
| BIT = 50 ppm & | ok | ok | ok | ok | ok | ok |
| CMIT/MIT = 10 ppm | | | | | | |
| benzisothiazolinone & | | | | | | |
| N-formal | | | | | | |
| BIT = 50 ppm & | ok | ok | ok | ok | ok | ok |
| N-formal = 120 ppm | | | | | | |

As is evident from the above table, by adding the mixtures according to the invention of benzisothiazolinone and a second biocidal component it is possible to enhance the activity of benzisothiazolinone considerably, resulting in antimicrobially, in particular antibacterially, more resistant suspensions, dispersions or slurries of minerals, fillers or pigments. Even though the active compound concentration is reduced with respect to the individual active compound BIT, with the given mixtures (see table) a considerably better total activity is obtained, i.e. the total activity against all microorganism species used for the test is maintained over a test period of 6 weeks.

1. Antimicrobially finished aqueous compositions of water-insoluble solids, comprising a mixture of 1,2-benzisothiazolin-3-one and at least one further biocidally active compound.

2. Preparation according to claim 1, characterized in that the water-insoluble solids are natural or synthetic minerals, fillers or pigments.

3. Preparation according to at least one of claims 1 and 2, characterized in that it comprises, as further biocidally active compound, at least one compound selected from the group of the isothiazolinones, formaldehyde, formaldehyde-releasing substances, bromine-containing biocides and o-phenylphenol.

4. Preparation according to at least one of claims 1 to 3, characterized in that it comprises a mixture of 1,2-benzisothiazolin-3-one with 5-chloro-2-methyl-4-isothiazolin-3-one and 2-methyl-4-isothiazolin-3-one.

5. Preparation according to at least one of claims 1 to 4, characterized in that it comprises a dispersion, suspension or slurry of aluminium hydroxide, aluminium silicate, titanium dioxide, iron oxide, kaolin, calcium carbonate and/or talcum which comprises a mixture of 1,2-benzisothiazolin-3-one with 5-chloro-2-methyl4-isothiazolin-3-one and 2-methyl-4-isothiazolin-3-one.

6. Process for producing a preparation according to claim 1, characterized in that water-insoluble solids are dispersed in water with addition of a dispersant and, if appropriate, further additives, and treated with a biocidally active compound mixture of 1,2-benzisothiazolin-3-one and at least one further biocidal compound, if appropriate with addition of one or more solvents and if appropriate further antimicrobially active compounds.

7. Use of a mixture of 1,2-benzisothiazolin-3-one and at least one further biocidally active compound from the group of the isothiazolinones, formaldehyde and formaldehyde-releasing substances, the bromine-containing biocides and o-phenylphenol for protecting aqueous preparations of water-insoluble solids against attack and destruction by microorganisms.

8. Use according to claim 7, characterized in that a mixture of 1,2-benzisothiazolin-3-one with 5-chloro-2-methyl4-isothiazolin-3-one and 2-methyl4-isothiazolin-3-one is employed.

9. Use of a mixture of 1,2-benzisothiazolin-3-one with 5-chloro-2-methyl-4-isothiazolin-3-one and 2-methyl-4-isothiazolin-3-one for protecting dispersions, suspensions or slurries of natural or synthetic minerals, fillers or pigments against attack and destruction by microorganisms.

10. Method for protecting aqueous preparations of water-insoluble solids against attack and destruction by microorganisms, characterized in that the preparation is either mixed with a mixture of 1,2-benzisothiazolin-3-one and at least one further biocidally active compound from the group of the isothiazolinones, formaldehyde and formaldehyde-releasing substances, the bromine-containing biocides and o-phenylphenol, and also, if appropriate, auxiliaries and additives, or the individual active compounds and, if appropriate, auxiliaries and additives are in each case metered separately to the preparation, where the mixing or metering in may be carried out during the process of producing the preparation or with the finished preparation.
